(19) United States
(12) Patent Application Publication
(10) Pub. No.: US 2024/0207893 A1
(43) Pub. Date: Jun. 27, 2024

(54) RESIN COMPOSITE LAMINATE, METHOD OF PRODUCING RESIN COMPOSITE LAMINATE AND STRETCHABLE DEVICE

(71) Applicant: TDK CORPORATION, Tokyo (JP)

(72) Inventor: Hajime AZUMA, Tokyo (JP)

(73) Assignee: TDK CORPORATION, Tokyo (JP)

(21) Appl. No.: 17/907,891

(22) PCT Filed: Jan. 31, 2022
(86) PCT No.: PCT/JP2022/003549

§ 371 Date: Aug. 29, 2022

(30) Foreign Application Priority Data
Mar. 31, 2021 (JP) 2021-060783

(51) Int. Cl. B05D 3/10

(52) U.S. Cl. CPC B05D 3/105; B05D 3/101; B05D 2201/02; B05D 2401/10; B05D 2503/00; B05D 2505/50

(57) ABSTRACT

This resin composite laminate includes a urethane resin layer containing a urethane resin which has a urethane bond and a siloxane bond, has a weight average molecular weight of 52,200 to 260,000, and is soluble in a solvent, and a polyimide resin layer containing a polyimide resin having an imide bond, and a peel strength between the urethane resin layer and the polyimide resin layer is 1.6 N or more per 10 mm in width.

### TECHNICAL FIELD

The present invention relates to a resin composite laminate, a method of producing a resin composite laminate and a stretchable device.

Priority is claimed on Japanese Patent Application No. 2021-060783, filed Mar. 31, 2021, the content of which is incorporated herein by reference.

### BACKGROUND ART

In recent years, wearable devices have been focused on. Wearable devices measure and monitor characteristics of specific parts of the human body. Wearable devices are used by being embedded in clothing or by being directly attached to the skin. Wearable devices are expected to be applied in a wide range of fields such as the fields of sports science and healthcare.

Wearable devices are preferably stretchable devices having stretchability that follow human movements and provide stress-free wearability. In addition, wearable devices include electrodes, wirings, electronic components, sensors and the like. Therefore, in wearable devices, it is necessary to consider sufficient heat resistance for a sheet layer on which electrodes, wirings, electronic components, sensors and the like are installed, and elements used for a sealing layer that seals them.

Examples of resins having favorable heat resistance include epoxy resins, polyimide resins, and polyamide resins. However, resins having favorable heat resistance have insufficient flexibility in many cases.

In addition, examples of resins having favorable flexibility include urethane resins, silicone resins, and acrylic resins. However, urethane resins, silicone resins, and acrylic resins, all of which are classified into types having favorable stretchability, have insufficient heat resistance to be used as the material of elements of wearable devices including electronic components.

Patent Document 1 describes a polyimide cover substrate including a polyimide film and an element protective layer formed of a urethane acrylate compound on at least one surface of the polyimide film.

Patent Document 2 describes a urethane modified polyimide-based resin solution containing a urethane modified polyimide-based resin (A) containing an amide-imide unit (i) composed of trimellitic acid derivatives and an aromatic diisocyanate component and a urethane unit (ii) composed of tricyclodecane dimethanol and an aromatic diisocyanate component, and one or more organic solvents (B) selected from the group consisting of cyclohexanone and cyclopentanone.

Patent Document 3 describes a sealing film-coated electronic component mounting substrate including a substrate, an electronic component mounting substrate including an electronic component mounted on the substrate, a resin layer that covers at least a part of the substrate and the electronic component, and a sealing film that covers at least a part of the substrate and the electronic component via the resin layer. In addition, Patent Document 3 describes that the resin layer is composed of a solvent-soluble resin as a main material, the sealing film is composed of a resin material as a main material, and the elongation percentage at a softening point obtained according to JIS K 6251 is 150% or more and 3,500% or less.

### CITATION LIST

### Patent Literature

[Patent Document 1]
   Published Japanese Translation No. 2016-521216 of the PCT International Publication
[Patent Document 2]
   Japanese Patent No. 6070911
[Patent Document 3]
   Japanese Unexamined Patent Application, First Publication No. 2019-134095

### SUMMARY OF INVENTION

### Technical Problem

As elements of stretchable devices, materials having sufficient stretchability and heat resistance are required. As such a material, it is conceivable to use a resin composite laminate in which a urethane resin layer containing a urethane resin having favorable stretchability and a polyimide resin layer containing a polyimide resin having favorable heat resistance are laminated.

However, such a resin composite laminate has a problem that the urethane resin layer and the polyimide resin layer easily peel off when stretched. In addition, because such a resin composite laminate easily creases when the resin composite laminate is bent, it is difficult to use it as an element of a stretchable device.

The present invention has been made in view of the above circumstances and an object of the present invention is to provide a resin composite laminate in which a urethane resin layer and a polyimide resin layer do not easily peel off and which is less likely to have creases even when the resin composite laminate is bent, and a method of producing the same.

In addition, an object of the present invention is to provide a stretchable device including an element which contains the resin composite laminate of the present invention, which is less likely to have creases even when the element is bent, and which has sufficient stretchability and heat resistance.

### Solution to Problem

The inventors conducted extensive studies in order to address the above problems.

As a result, the inventors have found that a resin composite laminate including a urethane resin layer containing a specific urethane resin soluble in a solvent and a polyimide resin layer containing a polyimide resin, and in which a peel strength between the urethane resin layer and the polyimide resin layer is 1.6 N or more per 10 mm in width may be used, and completed the present invention.

That is, the present invention relates to the following aspects.

[1] A resin composite laminate, including:
a urethane resin layer containing a urethane resin which has a urethane bond and a siloxane bond, has a weight average molecular weight of 52,200 to 260,000, and is soluble in a solvent, and
a polyimide resin layer containing a polyimide resin having an imide bond,
wherein a peel strength between the urethane resin layer and the polyimide resin layer is 1.6 N or more per 10 mm in width.
   [2] The resin composite laminate according to [1],
wherein the urethane resin has a group represented by the following General Formula (11), (21) or (31), a urethane bond, and a siloxane bond:

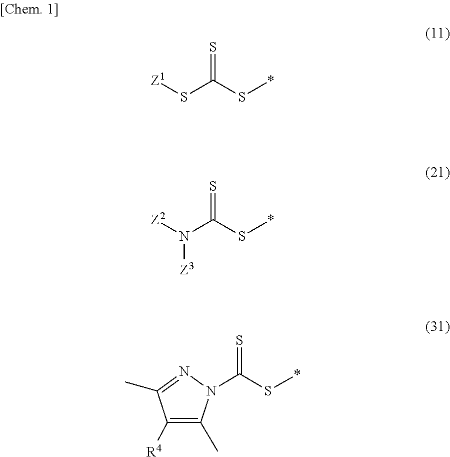

(in the formulae, Z¹ is an alkyl group, and one or more hydrogen atoms in the alkyl group may be substituted with a cyano group, a carboxy group or a methoxycarbonyl group, and two or more of the substituents may be the same as or different from each other; Z² is an alkyl group; Z³ is an aryl group; R⁴ is a hydrogen atom or a halogen atom; and the bond with the symbol * is formed with the bonding destination of the group represented by General Formula (11), (21) or (31)).
[3] The resin composite laminate according to [1] or [2],
wherein the polyimide resin is soluble in the solvent.
   [4] The resin composite laminate according to any one of [1] to [3],
wherein the polyimide resin is any one selected from a group consisting of a silicone modified polyimide resin, a polyamide-imide resin, an aromatic polyimide resin, an epoxy modified polyimide, and a urethane modified polyimide.
   [5] The resin composite laminate according to any one of [1] to [4],
wherein a thickness of the polyimide resin layer is 10 μm or less.
   [6] The resin composite laminate according to any one of [1] to [5],
wherein a tensile strength per 10 mm in width is 4.35 N or less.
   [7] A method of producing the resin composite laminate according to any one of [1] to [6], including:
a solidified layer forming process in which a solidified layer composed of any one selected from a group consisting of a solidified product obtained by solidifying by drying, a semi-cured product obtained by performing semi-curing, and a partially cured product obtained by performing partial curing, of a polyimide resin composition containing the polyimide resin is formed; and
an intermediate layer forming process in which a urethane resin composition containing the urethane resin and the solvent is applied onto the solidified layer, dried and solidified to form the urethane resin layer and the polyimide resin layer, and an intermediate layer is formed in contact with the urethane resin layer and the polyimide resin layer.
   [8] The method of producing a resin composite laminate according to [7],
wherein the polyimide resin is soluble in the solvent, and
wherein, in the intermediate layer forming process, the urethane resin composition is applied, and thus the polyimide resin contained in the solidified layer is dissolved in the solvent.
   [9] A stretchable device comprising an element containing the resin composite laminate according to any one of [1] to [6].

### Advantageous Effects of Invention

A resin composite laminate of the present invention includes a urethane resin layer containing a urethane resin which has a urethane bond and a siloxane bond, has a weight average molecular weight of 52,200 to 260,000, and is soluble in a solvent, and a polyimide resin layer containing a polyimide resin having an imide bond, and a peel strength between the urethane resin layer and the polyimide resin layer is 1.6 N or more per 10 mm in width. Therefore, the resin composite laminate of the present invention has favorable adhesion between the urethane resin layer and the polyimide resin layer and is unlikely to peel off. Moreover, the resin composite laminate of the present invention is less likely to have creases even when the resin composite laminate is bent.

In addition, since the resin composite laminate of the present invention includes a urethane resin layer containing a urethane resin which has a urethane bond and a siloxane bond and a weight average molecular weight of 52,200 to 260,000, it has favorable stretchability. In addition, since the resin composite laminate of the present invention has a polyimide resin layer containing a polyimide resin having an imide bond, it has favorable heat resistance. Accordingly, the resin composite laminate of the present invention is suitable as an element of a stretchable device.

In a method of producing a resin composite laminate of the present invention, a solidified layer composed of any one selected from a group consisting of a solidified product obtained by solidifying by drying, a semi-cured product obtained by performing semi-curing, and a partially cured product obtained by performing partial curing, of a polyimide resin composition containing a polyimide resin is formed, and a urethane resin composition containing a urethane resin and a solvent is applied onto the solidified layer, dried and solidified. Therefore, according to the method of producing a resin composite laminate of the present invention, a resin composite laminate of the present invention including a urethane resin layer, a polyimide resin layer, and an intermediate layer which is formed in contact with the urethane resin layer and the polyimide resin layer and integrated with the urethane resin layer and the polyimide resin layer by incorporating the urethane resin into the polyimide resin layer can be produced.

A stretchable device of the present invention includes an element containing the resin composite laminate of the present invention. Therefore, the stretchable device of the present invention is less likely to have creases even when the stretchable device is bent and has sufficient stretchability and heat resistance.

### BRIEF DESCRIPTION OF DRAWINGS

FIG. 1 is a schematic cross-sectional view showing an example of a resin composite laminate according to one embodiment of the present invention.

FIG. 2 is a schematic view showing an example of a stretchable device according to one embodiment of the present invention.

### DESCRIPTION OF EMBODIMENTS

In order to address the above problems, the inventors conducted studies as shown below.

That is, the inventors have focused on and studied the cause of peeling off between the urethane resin layer and the polyimide resin layer by stretching the resin composite laminate formed by laminating the urethane resin layer and the polyimide resin layer. The cause of peeling off of the resin composite laminate is that the stretchabilities of the urethane resin layer and the polyimide resin layer are different and therefore the difference in tensile stress between the urethane resin layer and the polyimide resin layer during stretching is large.

Therefore, as a method of preventing the resin composite laminate from easily peeling off, it is conceivable to improve stretchability of the polyimide resin layer and reduce the difference in stretchability between the urethane resin layer and the polyimide resin layer. However, even though a conventional polyimide resin has favorable stretchable, the stretchability is very small as compared with a urethane resin. That is, in the related art, there has been no polyimide resin having a small difference in stretchability from that of a urethane resin.

In addition, as a method of preventing a resin composite laminate from peeling off, it is conceivable to improve the adhesion between the urethane resin layer and the polyimide resin layer. Generally, the polyimide resin layer is prepared by a method of applying a resin composition containing a polyimide resin onto a base material, and heat-curing it. However, when the polyimide resin is heat-cured on the urethane resin layer in order to produce a resin composite laminate, the urethane resin layer deteriorates. Therefore, when the resin composite laminate formed by laminating the urethane resin layer and the polyimide resin layer is produced, a method of forming a polyimide resin layer on a peelable base material and attaching the polyimide resin layer peeled off from the base material onto the urethane resin layer is used. However, in the method of attaching the polyimide resin layer to the urethane resin layer, sufficient adhesion between the urethane resin layer and the polyimide resin layer could not be obtained.

In addition, as a method of preventing the resin composite laminate from peeling off, it is conceivable to provide a resin intermediate layer containing both the urethane resin and the polyimide resin between the urethane resin layer and the polyimide resin layer, and reduce the difference in tensile stress between the urethane resin layer and the polyimide resin layer during stretching. However, if the urethane resin and the polyimide resin before curing are mixed, the curing reaction is inhibited and thus it is difficult to form the resin intermediate layer.

Thus, the inventors focused on a resin composition containing a urethane resin dissolved in a solvent, and conducted extensive studies as shown below.

That is, the inventors found that, when a urethane resin composition containing a urethane resin which has a urethane bond and a siloxane bond, has a weight average molecular weight (Mw) of 52,200 to 260,000, and is soluble in a solvent is applied onto a base material, dried and solidified, a urethane resin layer having sufficient stretchability is obtained.

Then, the inventors produced a resin composite laminate by a method of applying the urethane resin composition onto a polyimide resin layer prepared by a method of performing heat-curing on a base material in place of the base material, and solidifying it. However, in the obtained resin composite laminate, it was not possible to prevent peeling off between the urethane resin layer and the polyimide resin layer. Specifically, the peel strength between the urethane resin layer and the polyimide resin layer was less than 1.6 N. In addition, the resin composite laminate was likely to have creases when the resin composite laminate was bent.

It is speculated that this is because, even if the urethane resin composition is applied onto the polyimide resin layer prepared by a method of performing heat-curing on the base material, the urethane resin does not enter the polyimide resin layer. As a result, it is speculated that an intermediate layer containing both the urethane resin and the polyimide resin was not formed between the urethane resin layer and the polyimide resin layer, and sufficient adhesion between the urethane resin layer and the polyimide resin layer could not be obtained.

Therefore, the inventors have focused on the state of a coating target surface to which the urethane resin composition is applied and additionally conducted extensive studies. As a result, the inventors found that the urethane resin composition may be applied onto a solidified layer composed of any one selected from the group consisting of a solidified product obtained by solidifying by drying, a semi-cured product obtained by performing semi-curing, and a partially cured product obtained by performing partial curing and drying and solidifying, of a resin composition containing a polyimide resin. In the resin composite laminate obtained in this manner, the peel strength between the urethane resin layer and the polyimide resin layer is 1.6 N or more, and the adhesion between the urethane resin layer and the polyimide resin layer is favorable. It is speculated that this is because the intermediate layer integrated with the urethane resin layer and the polyimide resin layer by incorporating the urethane resin into the polyimide resin layer is formed in contact with the urethane resin layer and the polyimide resin layer.

In addition, the inventors confirmed that, in the resin composite laminate obtained in this manner, the urethane resin layer and polyimide resin layer do not easily peel off and it is less likely to have creases even when the resin composite laminate is bent, and has sufficient stretchability and heat resistance, and completed the present invention.

Hereinafter, a resin composite laminate, a method of producing a resin composite laminate and a stretchable device of the present invention will be described in detail with reference to the drawings.

Here, in the drawings used in the following description, in order to facilitate understanding of features of the present invention, feature parts are enlarged for convenience of illustration in some cases, and dimensional proportions and the like of components are not necessarily the same as those of actual components.

### [Resin Composite Laminate]

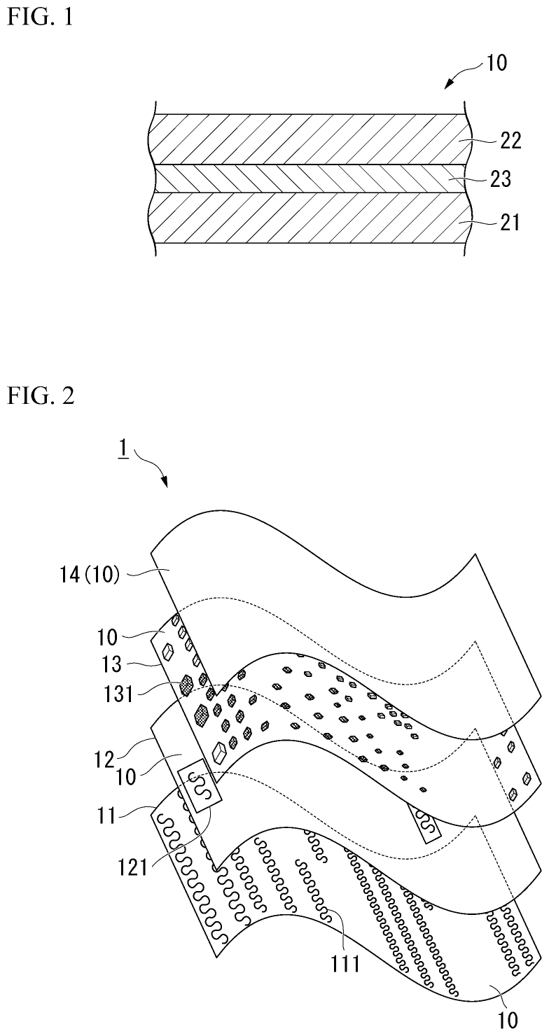

FIG. 1 is a schematic cross-sectional view showing an example of a resin composite laminate according to one embodiment of the present invention. As shown in FIG. 1, a resin composite laminate 10 of the present embodiment includes a urethane resin layer 21, a polyimide resin layer 22, and an intermediate layer 23 formed between the urethane resin layer 21 and the polyimide resin layer 22. In the resin composite laminate 10, the peel strength between the urethane resin layer and the polyimide resin layer is 1.6 N or more per 10 mm in width. The resin composite laminate 10 can be bend or stretchable.

### “Urethane Resin Layer”

The urethane resin layer 21 contains a urethane resin having a urethane bond and a siloxane bond. The urethane resin preferably has both a urethane bond and a siloxane bond in one molecule. Since the urethane resin has a urethane bond, it has high flexibility. In addition, since the urethane resin has a siloxane bond, hydrolysis of the urethane bond is minimized.

The urethane resin contained in the urethane resin layer 21 is soluble in a solvent. The urethane resin layer 21 is formed by applying and solidifying a urethane resin composition containing a urethane resin and a solvent.

The urethane resin is preferably soluble in the solvents N-methyl-2-pyrrolidone (NMP), γ-butyrolactone (GBL), N,N-dimethylacetamide (DMAc), methyl ethyl ketone (MEK), N,N-dimethylformamide (DMF), diethylene glycol monobutyl ether (BCA), diethylene glycol monobutyl ether acetate, diethylene glycol monoethyl ether acetate, diethylene glycol monomethyl ether acetate, acetone, ethanol, methanol, ethyl lactate, butyl lactate, toluene, isopropyl alcohol, isobutyl alcohol, ethyl acetate, and butyl acetate. The urethane resin is preferably soluble in any one or more selected from the group consisting of N-methyl-2-pyrrolidone (NMP), γ-butyrolactone (GBL), and N,N-dimethylacetamide (DMAc), which are solvents in which the polyimide resin is soluble.

The weight average molecular weight (Mw) of the urethane resin is 52,200 to 260,000 and preferably 61,000 to 250,000. Since the weight average molecular weight (Mw) of the urethane resin contained in the urethane resin layer 21 is 52,200 or more, the urethane resin layer 21 has sufficient strength. In addition, since the weight average molecular weight (Mw) of the urethane resin is 260,000 or less, the urethane resin layer 21 has sufficient stretchability. In addition, since the urethane resin has a weight average molecular weight (Mw) of 260,000 or less, it can be dissolved in a solvent.

In this specification, “weight average molecular weight” means a polystyrene-equivalent value measured by a gel permeation chromatography (GPC) method unless otherwise specified.

The urethane resin contained in the urethane resin layer 21 preferably has a group represented by the following General Formula (11), (21) or (31), a urethane bond, and a siloxane bond.

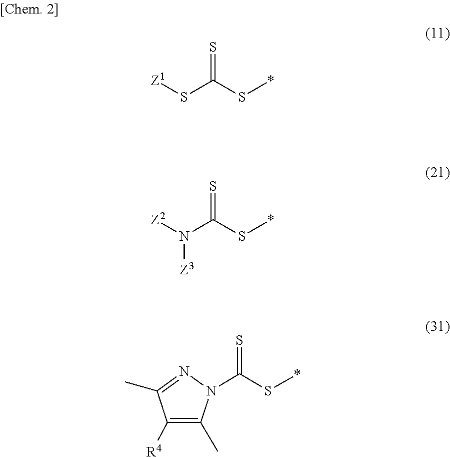

(in the formulae, Z¹ is an alkyl group, and one or more hydrogen atoms in the alkyl group may be substituted with a cyano group, a carboxy group or a methoxycarbonyl group, and two or more of the substituents may be the same as or different from each other; Z² is an alkyl group; Z³ is an aryl group; R⁴ is a hydrogen atom or a halogen atom; and the bond with the symbol * is formed with the bonding destination of the group represented by General Formula (11), (21) or (31)).

The urethane resin contained in the urethane resin layer 21 is obtained by performing a polymerization reaction using a resin having a urethane bond and a polymerizable unsaturated bond, a resin having a siloxane bond and a polymerizable unsaturated bond, and additionally an RAFT agent for performing reversible addition fragmentation chain transfer polymerization (in this specification, which may be abbreviated as an “RAFT polymerization”) from which a group represented by General Formula (11), (21) or (31) is derived.

When RAFT polymerization is performed, it is possible to prevent the resin during polymerization from gelling in a procedure of forming a cross-linked structure, and it is possible to obtain a resin component having a desired degree of polymerization and cross-linked state. That is, the urethane resin contained in the urethane resin layer 21 has a small variation in the degree of polymerization and the cross-linked state.

The resin having a urethane bond and a polymerizable unsaturated bond used for producing the urethane resin is an oligomer (in the present embodiment, it may be referred to as a “resin (a)”).

In addition, the resin having a siloxane bond and a polymerizable unsaturated bond used for producing the urethane resin is an oligomer (in the present embodiment, it may be referred to as a “resin (b)”).

The urethane resin is a polymer produced by polymerizing the resin (a) and the resin (b) at their polymerizable unsaturated bonds.

The resin (a) is not particularly limited as long as it has a urethane bond and a polymerizable unsaturated bond. Regarding the resin (a), for example, those having a (meth)acryloyl group as a group having a urethane bond and a polymerizable unsaturated bond are exemplary examples. Specifically, as the resin (a), urethane (meth)acrylate and the like are exemplary examples.

In this specification, “(meth)acrylate” refers to both an “acrylate” and a “methacrylate.” The same applies to terms similar to (meth)acrylate. For example, “(meth)acryloyl group” refers to both an “acryloyl group” and a “methacryloyl group.”

The weight average molecular weight (Mw) of the resin (a) is preferably 3,000 to 50,000, and more preferably 15,000 to 50,000. When the resin (a) having such a weight average molecular weight is used, a urethane resin having better properties can be obtained.

The resin (b) is not particularly limited as long as it has a siloxane bond and a polymerizable unsaturated bond. Regarding the resin (b), for example, various known silicone resins having a (meth)acryloyl group as a group having a polymerizable unsaturated bond are exemplary examples. Specifically, as the resin (b), for example, a modified-polydialkylsiloxane having a (meth)acryloyl group bonded to one end or both ends of a polydialkylsiloxane such as polydimethylsiloxane is an exemplary example.

The number average molecular weight (Mn) of the resin (b) is preferably 400 to 10,000, and more preferably 5,000 to 10,000. When the resin (b) having such a number average molecular weight is used, the urethane resin having better properties can be obtained.

In this specification, “number average molecular weight” means a polystyrene-equivalent value measured by a gel permeation chromatography (GPC) method unless otherwise specified.

In General Formula (11), Z¹ is an alkyl group. The alkyl group for Z¹ may be linear, branched or cyclic, and is preferably linear or branched and more preferably linear.

The linear or branched alkyl group for Z¹ preferably has 1 to 12 carbon atoms. Examples of such an alkyl group include a methyl group, ethyl group, n-propyl group, isopropyl group, n-butyl group, isobutyl group, sec-butyl group, tert-butyl group, n-pentyl group, isopentyl group, neopentyl group, tert-pentyl group, 1-methylbutyl group, 2-methylbutyl group, hexyl group, heptyl group, n-octyl group, isooctyl group, 2-ethylhexyl group, nonyl group, decyl group, undecyl group, and dodecyl group. The linear or branched alkyl group for Z¹ may have, for example, 1 to 8, 1 to 5, or 1 to 3 carbon atoms.

The cyclic alkyl group for Z¹ may be monocyclic or polycyclic, and is preferably monocyclic.

The cyclic alkyl group for Z¹ preferably has 3 to 6 carbon atoms. Examples of such an alkyl group include a cyclopropyl group, cyclobutyl group, cyclopentyl group, and cyclohexyl group.

One or more hydrogen atoms in the alkyl group for Z¹ may or may not be substituted with a cyano group (—CN), a carboxy group (—C(═O)—OH) or a methoxycarbonyl group (—C(═O)—OCH₃).

When two or more hydrogen atoms in the alkyl group for Z¹ are substituted with a cyano group, a carboxy group or a methoxycarbonyl group, two or more of the substituents may be the same as or different from each other. When the hydrogen atom is substituted with a cyano group, a carboxy group or a methoxycarbonyl group, all hydrogen atoms in the alkyl group may be substituted, and it is preferable that there be a hydrogen atom that is not substituted. The number of hydrogen atoms substituted in the alkyl group is preferably 1 or 2, and more preferably 1.

Regarding the alkyl group for Z¹ in which a hydrogen atom is substituted with a cyano group, a carboxy group or a methoxycarbonyl group, for example, a 1-carboxyethyl group (—CH(CH₃)COOH), 2-carboxyethyl group (—CH₂CH₂COOH), 4-carboxy-2-cyano-sec-butyl group (—C(CH₃)(CN)CH₂CH₂COOH), 2-cyano-4-methoxycarbonyl-sec-butyl group (—C(CH₃)(CN)CH₂CH₂COOCH₃), 1-cyano-1-methylethyl group (—C(CH₃)(CN)CH₃), cyanomethyl group (—CH₂CN), 1-cyano-1-methyl-n-propyl group (—C(CH₃)(CN)CH₂CH₃), and 2-cyano-2-propyl group (—C(CH₃)(CN)CH₃) are exemplary examples, and a 2-carboxyethyl group is preferable.

Z¹ is preferably a dodecyl group (n-dodecyl group) or a 2-carboxyethyl group.

In General Formula (21), Z² is an alkyl group. Examples of alkyl groups for Z² include the same alkyl groups as for Z¹.

The alkyl group for Z² is preferably linear or branched, and more preferably linear. The linear or branched alkyl group for Z² may have, for example, 1 to 12, 1 to 8, 1 to 5, or 1 to 3 carbon atoms. Z² is preferably a methyl group.

In General Formula (21), Z³ is an aryl group. The aryl group for Z³ may be monocyclic or polycyclic, and is preferably monocyclic.

The aryl group for Z³ preferably has 6 to 12 carbon atoms. Examples of such an aryl group include a phenyl group, 1-naphthyl group, 2-naphthyl group, o-tolyl group, m-tolyl group, p-tolyl group, and xylyl group (dimethylphenyl group). Z³ is preferably a phenyl group.

In General Formula (31), R⁴ is a hydrogen atom or a halogen atom.

Examples of halogen atoms for R⁴ include a fluorine atom, a chlorine atom, a bromine atom, and an iodine atom, and a chlorine atom is preferable. R⁴ is preferably a hydrogen atom or a chlorine atom.

In General Formula (11), (21) or (31), the bond with the symbol * is formed with the bonding destination of the group represented by General Formula (11), (21) or (31), that is, an end part in the polymer of the resin (a) and the resin (b).

Examples of RAFT agents from which a group represented by General Formula (11) is derived include compounds represented by the following General Formula (1) (in this specification, it may be abbreviated as an “RAFT agent (1)”).

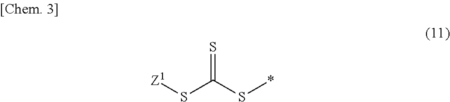

(in the formula, R¹ is an alkyl group, and one or more hydrogen atoms in the alkyl group may be substituted with a cyano group, a carboxy group or a methoxycarbonyl group, and two or more of the substituents may be the same as or different from each other; and Z¹ is the same as Z¹ in General Formula (11)).

Regarding the alkyl group in which one or more hydrogen atoms for R¹ in General Formula (1) may be substituted with a cyano group, a carboxy group or a methoxycarbonyl group, the same alkyl groups in which one or more hydrogen atoms for Z¹ may be substituted with a cyano group, a carboxy group or a methoxycarbonyl group are exemplary example, and the mode of substitution of hydrogen atoms for R¹ is the same as the mode of substitution of hydrogen atoms for Z¹.

R¹ is preferably a 1-carboxyethyl group, 4-carboxy-2-cyano-sec-butyl group, 1-cyano-1-methylethyl group), 2-cyano-4-methoxycarbonyl-sec-butyl group, cyanomethyl group, or 2-cyano-2-propyl group.

Z¹ in General Formula (1) is the same as Z¹ in General Formula (11).

When the RAFT agent (1) is used, according to a polymerization reaction, a group represented by General Formula R¹ is bonded to an end part of the polymer of the resin (a) and the resin (b) to which a group represented by General Formula (11) is not bonded.

Examples of RAFT agents from which a group represented by General Formula (21) is derived include compounds represented by the following General Formula (2) (in this specification, it may be abbreviated as an “RAFT agent (2)”).

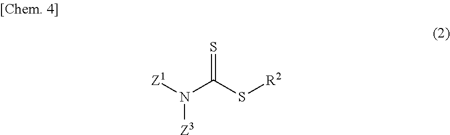

(in the formula, R² is an alkyl group, and one or more hydrogen atoms in the alkyl group may be substituted with a cyano group, a carboxy group or a methoxycarbonyl group, and two or more of the substituents may be the same as or different from each other; and Z² and Z³ are the same as Z² and Z³ in General Formula (21)).

Regarding the alkyl group in which one or more hydrogen atoms for R² in General Formula (2) may be substituted with a cyano group, a carboxy group or a methoxycarbonyl group, the same alkyl groups in which one or more hydrogen atoms for Z¹ may be substituted with a cyano group, a carboxy group or a methoxycarbonyl group are exemplary examples, and the mode of substitution of hydrogen atoms for R² is the same as the mode of substitution of hydrogen atoms for Z¹.

R² is preferably a cyanomethyl group.

Z² and Z³ in General Formula (2) are the same as Z² and Z³ in General Formula (21).

When the RAFT agent (2) is used, according to a polymerization reaction, a group represented by General Formula R² is bonded to an end part of the polymer of the resin (a) and the resin (b) to which a group represented by General Formula (21) is not bonded.

Examples of RAFT agents from which a group represented by General Formula (31) is derived include compounds represented by the following General Formula (3) (in this specification, it may be abbreviated as an “RAFT agent (3)”).

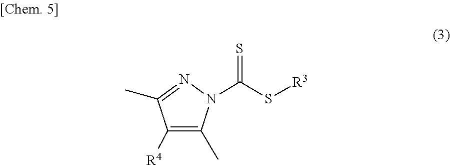

(in the formula, R³ is an alkyl group, and one or more hydrogen atoms in the alkyl group may be substituted with a cyano group, a carboxy group or a methoxycarbonyl group, and two or more of the substituents may be the same as or different from each other; and R⁴ is the same as Z⁴ in General Formula (31)).

Regarding the alkyl group in which one or more hydrogen atoms for R³ in General Formula (3) may be substituted with a cyano group, a carboxy group or a methoxycarbonyl group, the same alkyl groups in which one or more hydrogen atoms for Z¹ may be substituted with a cyano group, a carboxy group or a methoxycarbonyl group are exemplary examples, and the mode of substitution of hydrogen atoms for R³ is the same as the mode of substitution of hydrogen atoms for Z¹.

R³ is preferably a cyanomethyl group or 1-cyano-1-methyl-n-propyl group.

R⁴ in General Formula (3) is the same as R⁴ in General Formula (31).

When the RAFT agent (3) is used, according to a polymerization reaction, a group represented by General Formula R³ is bonded to an end part of the polymer of the resin (a) and the resin (b) to which a group represented by General Formula (31) is not bonded.

As the raw material of the urethane resin, in addition to the resin (a) and the resin (b), other polymerizable components not corresponding to these may be used.

Examples of other polymerizable components include a monomer or oligomer having a polymerizable unsaturated bond. Specific examples of other polymerizable components include (meth)acrylic acid alkyl esters such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, pentyl (meth)acrylate, hexyl (meth)acrylate, heptyl (meth)acrylate, 2-ethylhexyl (meth)acrylate, isooctyl (meth)acrylate, n-octyl (meth)acrylate, n-nonyl (meth)acrylate, isononyl (meth)acrylate, and decyl (meth)acrylate.

As the raw material of the urethane resin, in addition to the above components, as necessary, one or more other non-polymerizable components may be used. The other non-polymerizable components can be arbitrarily selected according to purposes, and are preferably a non-conductive component.

The urethane resin contained in the urethane resin layer 21 can be produced, for example, by the following method.

It can be produced by a method of preparing a raw material mixture in which the resin (a), the resin (b), the RAFT agent (that is, the RAFT agent (1), the RAFT agent (2) or the RAFT agent (3)), a polymerization initiator (in this specification, it may be referred to as a “polymerization initiator (c)”), a solvent, other polymerizable components that are used as necessary, and other non-polymerizable components that are used as necessary are mixed, and performing a polymerization reaction in the raw material mixture to produce a urethane resin.

The resin (a) contained in the raw material mixture may be of only one type or of two or more types. In the raw material mixture, the amount of the resin (a) in the components (in other words, in “solid content”) other than the solvent in the raw material mixture is preferably 60 to 99 mass % and more preferably 80 to 98 mass %. When the amount is 60 mass % or more, a urethane resin having favorable flexibility is obtained. When the amount is 99 mass % or less, a urethane resin having excellent strength can be obtained.

The resin (b) contained in the raw material mixture may be of only one type or of two or more types. In the raw material mixture, the amount of the resin (b) with respect to an amount of 100 parts by mass of the resin (a) is preferably 0.2 to 25 parts by mass, more preferably 0.2 to 20 parts by mass, and still more preferably 0.2 to 17 parts by mass. When the amount is 0.2 parts by mass or more, the water repellency of the urethane resin is improved more apparently. When the amount is 25 parts by mass or less, excessive use of the resin (b) can be avoided, and it is possible to prevent the urethane resin layer 21 from becoming harder than necessary and the uniformity of the urethane resin layer 21 from decreasing.

The RAFT agent (RAFT agents (1) to (3)) contained in the raw material mixture may be of only one type or of two or more types, and generally, only one type is sufficient. In the raw material mixture, the amount of the RAFT agent with respect to an amount of 100 parts by mass of the resin (a) is preferably 0.03 to 5 parts by mass, more preferably 0.03 to 4.5 parts by mass, and still more preferably 0.03 to 4 parts by mass. When the amount is 0.03 parts by mass or more, the effect obtained using the RAFT agent can be obtained more significantly. When the amount is 5 parts by mass or less, excessive use of the RAFT agent can be avoided.

The polymerization initiator (c) is not particularly limited, and known polymerization initiators can be used. Examples of polymerization initiators (c) include dimethyl-2,2′-azobis(2-methylpropionate) and azobisisobutyronitrile. The polymerization initiator (c) contained in the raw material mixture may be of only one type or of two or more types, and generally, only one type is sufficient.

In the raw material mixture, the amount of the polymerization initiator (c) with respect to the amount of 100 parts by mass of the resin (a) is preferably 0.5 to 5 parts by mass, more preferably 0.7 to 4 parts by mass, and still more preferably 0.9 to 3 parts by mass. When the amount is 0.5 parts by mass or more, the polymerization reaction proceeds more smoothly. When the amount is 5 parts by mass or less, excessive use of the polymerization initiator (c) can be avoided.

The solvent is not particularly limited as long as it does not exhibit the reactivity with each of the above formulation components used when the raw material mixture is prepared or the polymerization reaction product, and a solvent having favorable solubility for each formulation component is preferable.

Examples of solvents include methyl ethyl ketone (MEK), diethylene glycol monobutyl ether acetate, diethylene glycol monoethyl ether acetate, diethylene glycol monomethyl ether acetate, butyl acetate, ethyl acetate, ethyl lactate, and butyl lactate.

The solvent contained in the raw material mixture may be of only one type or of two or more types.

If the reaction solution obtained after the polymerization reaction is directly used as a urethane resin composition when the urethane resin layer 21 is formed, it is preferable to use methyl ethyl ketone (MEK), diethylene glycol monobutyl ether acetate, diethylene glycol monoethyl ether acetate, diethylene glycol monomethyl ether acetate, butyl acetate, or butyl lactate as the solvent.

Regarding the amount of the solvent used, the total amount of components other than the solvent in the raw material mixture with respect to the total amount of the raw material mixture is preferably an amount of 5 to 30 mass %, and more preferably an amount of 10 to 25 mass %. When the amount of the solvent used is within such a range, the resin component (I) having better properties can be obtained more smoothly.

Other polymerizable components contained in the raw material mixture may be of only one type or of two or more types. When other polymerizable components are used, the amount of the other polymerizable components in the raw material mixture with respect to an amount of 100 parts by mass of the resin (a) is preferably 5 to 55 parts by mass, more preferably 10 to 50 parts by mass, and still more preferably 15 to 45 parts by mass. When the amount is 5 parts by mass or more, the effect obtained using the other polymerizable components can be obtained more significantly. When the amount is 55 parts by mass or less, the stretchability of the urethane resin is further improved.

In the raw material mixture, the total amount of the resin (a), the resin (b), the RAFT agent, the polymerization initiator (c), and other polymerizable components (if these are used), with respect to the total amount of 100 parts by mass of components (that is, the above solid content) other than the solvent in the raw material mixture is preferably 90 to 100 parts by mass, more preferably 95 to 100 parts by mass, and may be, for example, 97 to 100 parts by mass or 99 to 100 parts by mass. When the amount is 90 parts by mass or more, the effects of the present invention can be obtained more significantly.

The polymerization reaction for synthesizing the urethane resin is preferably performed in an atmosphere of an inert gas such as nitrogen gas, helium gas, or argon gas.

The temperature (reaction temperature) at which a polymerization reaction is performed is preferably 70 to 110° C. and more preferably 80 to 100° C.

The polymerization reaction time (reaction time) may be appropriately adjusted according to the type of raw materials used and the reaction temperature, and may be, for example, 5 to 240 minutes.

In the present embodiment, when the polymerization reaction of the resin (a) and the resin (b) is performed using the RAFT agent (1), (2) or (3), the polymerization reaction can stably proceed. That is, the urethane resin can be stably synthesized so that the composition, the molecular weight distribution, the structure and the like are within a certain range. In particular, since the reaction rate is appropriately adjusted during the polymerization reaction, the reaction rapidly proceeds, and the viscosity of the reaction solution rapidly increases, and in a procedure of forming a cross-linked structure, the problem of gelling can be reduced. Therefore, in the present embodiment, a urethane resin having a desired degree of polymerization and cross-linked state is stably obtained.

As a method of performing radical polymerization, in addition to RAFT polymerization using an RAFT agent, atom transfer radical polymerization (ATRP) and nitroxide-mediated polymerization (NMP) are known. However, the ATRP has a disadvantage that it is necessary to perform a polymerization reaction at a high concentration of a catalyst containing a transition metal. In addition, the NMP has a disadvantage that it is difficult to control the polymerization reaction and its versatility is low. Due to these disadvantages, these methods are not suitable for producing the urethane resin of the present embodiment.

On the other hand, in the present embodiment, when RAFT polymerization using the RAFT agent (1), (2) or (3) is selected, a urethane resin having desired properties can be stably produced with high versatility.

In the present embodiment, the urethane resin composition used when the urethane resin layer 21 is formed contains a urethane resin and a solvent.

In the present embodiment, the reaction solution obtained after the polymerization reaction for synthesizing the urethane resin may be directly used as a urethane resin composition when the urethane resin layer 21 is formed, and the result obtained by performing a known post-treatment on the obtained reaction solution may be used as the urethane resin composition. In addition, the reaction solution may be purified by a known purification method to take out only the urethane resin, mixed with a solvent, and used as a urethane resin composition.

The urethane resin layer 21 may contain a resin other than the urethane resin, as necessary. As the other resin, it is preferable to use a resin that has favorable stretchability and is soluble in a solvent, and examples thereof include silicone resins, acrylic resins, methacrylic resins, and fluorine resins.

The thickness of the urethane resin layer 21 is preferably 10 to 1,000 μm, and more preferably 20 to 300 μm. When the thickness of the urethane resin layer 21 is 10 μm or more, the resin composite laminate 10 has sufficient strength and favorable stretchability. When the thickness of the urethane resin layer 21 is 1,000 μm or less, the urethane resin layer 21 can be easily formed by applying a urethane resin composition, and drying and solidifying it, and moreover, the resin composite laminate 10 has sufficient stretchability.

The thickness is measured using a contact-type film thickness measuring device (Digimicro, READOUT commercially available from Nikon Corporation), and the value immediately after coming in contact with the film is measured as the film thickness. This is the same as for the polyimide resin layer 22.

### “Polyimide Resin Layer”

The polyimide resin layer 22 contains a polyimide resin having an imide bond. Since the polyimide resin has an imide bond, it has favorable heat resistance. The polyimide resin layer 22 is obtained by forming the urethane resin layer 21 on a solidified layer composed of any one selected from the group consisting of a solidified product obtained by solidifying by drying, a semi-cured product obtained by performing semi-curing, and a partially cured product obtained by performing partial curing, of a polyimide resin composition containing a polyimide resin, and then curing it as necessary.

The polyimide resin contained in the polyimide resin layer 22 is preferably soluble in a solvent in which the urethane resin contained in the urethane resin layer 21 is soluble. In this case, for example, the polyimide resin layer 22 can be formed by applying a polyimide resin composition containing a polyimide resin onto a base material and solidifying it by drying. Therefore, it is not necessary to heat-cure the polyimide resin, and the polyimide resin layer 22 can be formed on the base material without causing damage due to heat-curing of the polyimide resin. In addition, since the polyimide resin layer 22 can be formed by the above method, a thin polyimide resin layer 22 can be easily formed. As a result, it is possible to obtain the resin composite laminate 10 which has favorable adhesion between the urethane resin layer and the polyimide resin layer, and is much less likely to have creases and does not peel off as easily even when the resin composite laminate 10 is bent.

In addition, when the polyimide resin is soluble in a solvent in which the urethane resin contained in the urethane resin layer 21 is soluble, the following effects can be obtained. That is, when a urethane resin composition containing a urethane resin dissolved in a solvent is applied onto the solidified layer of the polyimide resin composition containing a polyimide resin, both the urethane resin and the polyimide resin can be dissolved in the solvent and solidified. As a result, the urethane resin diffuses in the solidified layer, and the intermediate layer 23 which contains both the urethane resin and the polyimide resin and is integrated with the urethane resin layer 21 and the polyimide resin layer 22 by incorporating the urethane resin into the polyimide resin layer 22 is easily and reliably formed between the urethane resin layer 21 and the polyimide resin layer 22. Therefore, it is possible to obtain the resin composite laminate 10 that does not peel off as easily and less likely to have creases even when the resin composite laminate 10 is bent.

In addition, when the polyimide resin is soluble in a solvent in which the urethane resin contained in the urethane resin layer 21 is soluble, a polyimide resin composition containing no curing agent can be used.

The polyimide resin is preferably any one selected from the group consisting of aromatic polyimide resins, silicone modified polyimide resins, polyamide-imide resins, epoxy modified polyimide resins, and urethane modified polyimide resins. Since these polyimide resins have favorable heat resistance and stretchability, the resin composite laminate 10 does not peel off as easily and has excellent heat resistance. As the polyimide resin, it is more preferable to use any one selected from the group consisting of aromatic polyimide resins, silicone modified polyimide resins, and polyamide-imide resins.

Examples of aromatic polyimide resins include aromatic polyimide resins having an aliphatic hydrocarbon chain or an alicyclic framework. Since the aromatic polyimide resin contains a large amount of conjugated systems in the molecular structure, it has particularly excellent heat resistance among the polyimide resins. In addition, the aromatic polyimide resin can be easily bonded to other compounds. Therefore, as the aromatic polyimide resin, as necessary, a resin given a function other than heat resistance by introducing a functional group may be used.

As the silicone modified polyimide resin, for example, a resin having a framework formed by polymerizing BPDA(3,3′,4,4′-biphenyltetracarboxylic acid dianhydride) and having a silicone structure introduced into the framework can be used.

As the silicone modified polyimide resin, specifically, a polyimide resin represented by the following General Formula (5) can be used.

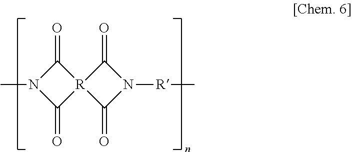

(in the formula, R is an aromatic hydrocarbon group, R′ is a repeating unit composed of —Si—O—Si— or —C—Si—O—Si—C—, the number of repetitions is 1 or more; and n is 5 to 400).

The polyimide resin represented by Formula (5) has hydrophobicity and favorable mechanical properties due to inclusion of a siloxane bond. When the polyimide resin is a silicone modified polyimide resin represented by Formula (5), the resin composite laminate 10 has better adhesion between the urethane resin layer 21 and the polyimide resin layer 22 and an excellent tensile property. In the polyimide resin represented by Formula (5), the number of repetitions of the repeating unit R′ is 1 or more. The upper limit of the number of repetitions of R′ may be within a range in which the heat resistance required for the polyimide resin layer 22 can be secured, and can be appropriately determined according to applications of the resin composite laminate 10 and the like.

Examples of polyamide-imide resins include polyamide-imides obtained by reacting a diisocyanate compound such as 4,4′-diphenylmethane diisocyanate with a tribasic acid anhydride such as trimellitic acid anhydride.

The polyimide resin layer 22 may contain a resin other than the polyimide resin, as necessary. As the other resin, it is preferable to use a resin which has favorable heat resistance and is soluble in a solvent, and examples thereof include polyamide resins, epoxy resins, and silicone resins.

The thickness of the polyimide resin layer 22 is preferably 1 to 10 μm and more preferably 3 to 10 μm. When the thickness of the polyimide resin layer 22 is 1 μm or more, the resin composite laminate 10 has better heat resistance. When the thickness of the polyimide resin layer 22 is 10 μm or less, the resin composite laminate 10 has better adhesion between the urethane resin layer 21 and the polyimide resin layer 22 and is much less likely to have creases even when the resin composite laminate 10 is bent. In addition, if the thickness of the polyimide resin layer 22 is 10 μm or less, when the polyimide resin layer 22 is formed using a method of applying a polyimide resin composition containing a polyimide resin, and drying and solidifying it, the drying temperature can be lowered. Therefore, it is possible to prevent damage caused by drying the polyimide resin composition. In addition, when the polyimide resin layer 22 is formed using the above method, it is possible to remove the solvent contained in the polyimide resin composition in a short time and it is possible to efficiently form the polyimide resin layer 22.

### “Intermediate Layer”

As shown in FIG. 1, the intermediate layer 23 is formed between the urethane resin layer 21 and the polyimide resin layer 22. The intermediate layer 23 is formed in contact with the urethane resin layer 21 and the polyimide resin layer 22. The intermediate layer 23 may be formed on the entire surface between the urethane resin layer 21 and the polyimide resin layer 22, or may be partially formed. The intermediate layer 23 is integrated with the urethane resin layer 21 and the polyimide resin layer 22 by incorporating the urethane resin into the polyimide resin layer 22. The intermediate layer 23 improves the adhesion between the urethane resin layer 21 and the polyimide resin layer 22, the urethane resin layer 21 and the polyimide resin layer 22 do not easily peel off, and the resin composite laminate 10 is less likely to have creases even when the resin composite laminate 10 is bent.

The intermediate layer 23 contains a urethane resin and a polyimide resin. When the resins contained in the urethane resin layer 21 and the polyimide resin layer 22 contain resins other than the urethane resin and the polyimide resin, the intermediate layer 23 may contain other resins corresponding to the resins contained in the urethane resin layer 21 and the polyimide resin layer 22.

It can be confirmed that the intermediate layer 23 is a layer containing a urethane resin and a polyimide resin using high-precision infrared spectroscopic analysis and high-precision Raman spectroscopy.

In the resin composite laminate 10 of the present embodiment, the peel strength between the urethane resin layer 21 and the polyimide resin layer 22 is 1.6 N or more per 10 mm in width, and preferably 3.5 N or more. The resin composite laminate 10 having a peel strength of 1.6 N or more per 10 mm in width has the urethane resin layer 21 and the polyimide resin layer 22 that do not easily peel off, is less likely to have creases even when the resin composite laminate 10 is bent, and is suitable as an element of a stretchable device.

The peel strength between the urethane resin layer 21 and the polyimide resin layer 22 per 10 mm in width is preferably 50 N or less and more preferably 10 N or less. The resin composite laminate 10 having a peel strength of 50 N or less per 10 mm in width has favorable tensile strength because the decrease in strength of polyimide resin layer 22 due to formation of the intermediate layer 23 between the urethane resin layer 21 and the polyimide resin layer 22 is small.

When the resin composite laminate 10 has a width of less than 10 mm, the value converted from the measured value of the peel strength to the peel strength at a width of 10 mm is used as a peel strength per 10 mm in width.

The resin composite laminate 10 of the present embodiment has a tensile strength per 10 mm in width that is preferably 0.2 to 4.35 N and more preferably 0.3 to 1.0 N. When the tensile strength per 10 mm in width is 0.2 N or more, the resin composite laminate 10 has sufficient strength. The resin composite laminate 10 having a tensile strength of 4.35 N or less per 10 mm in width has favorable flexibility, stress is dispersed and unlikely to be applied even if the resin composite laminate 10 is bent or stretched, and a stress difference is unlikely to occur between the urethane resin layer 21 and the polyimide resin layer 22. Therefore, the urethane resin layer 21 and the polyimide resin layer 22 do not easily peel off, and the resin composite laminate 10 is less likely to have creases even when the resin composite laminate 10 is bent, and is suitable as an element of a stretchable device.

When the resin composite laminate 10 has a width of less than 10 mm, the value converted from the measured value of the tensile strength to the tensile strength per 10 mm in width is used as the tensile strength per 10 mm in width.

The resin composite laminate 10 of the present embodiment has an elongation per 10 mm in width that is preferably 20 to 100% and more preferably 40 to 80%. The resin composite laminate 10 having an elongation of 20% or more per 10 mm in width has favorable stretchability and is suitable as an element of a stretchable device. The resin composite laminate 10 having an elongation of 100% or less per 10 mm in width is preferable because the polyimide resin layer 22 is less likely to break due to stretching.

When the resin composite laminate 10 has a width of less than 10 mm, the value converted from the measured value of the elongation to the elongation at a width of 10 mm is used as an elongation per 10 mm in width.

The thickness of the resin composite laminate 10 of the present embodiment is preferably 1 to 2,000 μm, and may be, for example, 5 to 1,000 μm. When the thickness of the resin composite laminate 10 is 1 μm or more, the strength of the resin composite laminate 10 becomes favorable. When the thickness of the resin composite laminate 10 is 2,000 μm or less, the flexibility of the resin composite laminate 10 becomes favorable.

### [Method of Producing Resin Composite Laminate]

The resin composite laminate 10 of the present embodiment can be produced by, for example, the following production method.

### “Solidified Layer Forming Process”

In order to produce the resin composite laminate 10 of the present embodiment, first, a polyimide resin composition containing a polyimide resin is produced. The polyimide resin composition can be obtained by, for example, mixing a polyimide resin and a solvent, and dissolving the polyimide resin in the solvent.

Next, a solidified layer composed of any one selected from the group consisting of a solidified product obtained by applying a polyimide resin composition onto a base material and solidifying it by drying, a semi-cured product obtained by performing semi-curing, and a partially cured product obtained by performing partial curing is formed.

As the base material, a known peelable base material can be used. In addition, the resin composite laminate 10 produced in advance or an element containing the resin composite laminate 10 may be used as a base material. In this case, it is possible to easily produce a laminate in which a plurality of resin composite laminates 10 are laminated. This method is suitable for producing a stretchable device in which a plurality of elements including the resin composite laminate 10 are laminated or the like.

The method of applying a polyimide resin composition is not particularly limited, and for example, known methods using various coaters, wire bars or the like can be used for application.

The state of the solidified layer may be any one state selected from the group consisting of a solidified product obtained by solidifying by drying, a semi-cured product obtained by performing semi-curing and a partially cured product obtained by performing partial curing, of the composition by appropriately adjusting the formulation of the polyimide resin composition, and drying conditions or curing conditions of the applied polyimide resin composition.

When the polyimide resin composition is solidified by drying, the drying temperature is preferably 70 to 250° C., and may be, for example, 80 to 110° C. When the drying temperature is 70° ° C. or higher, the resin composite laminate 10 can be efficiently produced. When the drying temperature is 250° ° C. or lower, the base material is not damaged by drying the polyimide resin composition, and the solvent can be removed while minimizing shrinkage of the solidified layer due to the temperature change.

The drying time of the polyimide resin composition can be appropriately set according to the drying temperature, and may be, for example, 1 to 120 minutes, and is preferably 1 to 60 minutes. When the drying time is within such a range, a solidified product having favorable properties can be efficiently produced.

The completion of solidification (formation of a solidified layer) by drying the polyimide resin composition can be confirmed by, for example, performing thermogravimetric analysis, which showed that no change in the mass of the polyimide resin composition being dried.

When the polyimide resin composition is semi-cured to obtain a semi-cured product, for example, it is preferable to perform drying at 70 to 150° C. and then heating and curing in a nitrogen atmosphere at 180 to 300° C. In the case of the semi-cured product, the heating time for curing is preferably 5 to 90 minutes, and more preferably 5 to 30 minutes. When the drying temperature, the heating temperature, and the heating time are within such a range, a solidified product having favorable properties can be efficiently produced.

When the polyimide resin composition is semi-cured to obtain a semi-cured product, formation of the semi-cured product (solidified layer) can be confirmed using, for example, any one or more of the following methods. Thermogravimetric analysis is performed, and a thermogravimetric curve is compared with a cured film. A tensile test is performed, and a tensile strength is compared with the cured film. An electrical insulation test is performed, and the electrical insulation is compared with the cured film. The semi-cured product needs to be used in consideration of its low electrical insulation as compared with the cured film.

When the polyimide resin composition is partially cured to obtain a partially cured product with the remainder being a semi-cured product, for example, it is preferable to perform drying at 70 to 150° C. and then heat-curing in a nitrogen atmosphere at 180 to 350° ° C. for 20 to 120 minutes. When the drying temperature, the heating temperature, and the heating time are within such a range, a solidified product having favorable properties can be efficiently produced.

When the polyimide resin composition is partially cured to obtain a partially cured product with the remainder being a semi-cured product, the formation of the partially cured product (solidified layer) can be confirmed by, for example, any one or more of the thermogravimetric curve obtained by thermogravimetric analysis, the value of the tensile strength obtained by the tensile test, and the value of the electrical insulation obtained by the electrical insulation test.

### “Intermediate Layer Forming Process”

Next, a urethane resin composition containing a urethane resin and a solvent is applied to a part or all of the solidified layer and solidified. Accordingly, the urethane resin is incorporated into the solidified layer and solidified. As a result, the urethane resin layer 21 and the polyimide resin layer 22 are formed, and the intermediate layer 23 integrated with the urethane resin layer 21 and the polyimide resin layer 22 is formed between the urethane resin layer 21 and the polyimide resin layer 22.

The method of applying a urethane resin composition is not particularly limited, and for example, a known method using various coaters, wire bars or the like can be used.

As the method of solidifying the urethane resin composition, for example, a method of drying the solidified layer to which the urethane resin composition is applied can be used.

The drying temperature of the urethane resin composition is preferably 25 to 150° C., and may be, for example, 70 to 120° C. When the drying temperature is 25° C. or higher, the resin composite laminate 10 can be efficiently produced. A drying temperature of 150° C. or lower is preferable because it makes damage such as deformation of the resin composite laminate 10 due to an excessively high drying temperature unlikely to occur.

The drying time of the urethane resin composition may be appropriately set according to the drying temperature, and is preferably 10 to 120 minutes and more preferably 10 to 90 minutes. When the drying time is within such a range, the resin composite laminate 10 having favorable properties can be efficiently produced.

The completion of solidification (formation of the resin composite laminate 10) by drying the urethane resin composition can be confirmed by, for example, the fact no clear change was observed in the mass of the resin composite laminate 10 being dried.

In the production method of the present embodiment, the polyimide resin is soluble in the solvent contained in the urethane resin layer composition, and in the intermediate layer forming process, it is preferable to apply the urethane resin composition and dissolve the polyimide resin contained in the solidified layer in the solvent. In this case, when the urethane resin composition is applied, both the urethane resin and the polyimide resin can be dissolved and solidified in the solvent. As a result, the intermediate layer 23 which contains both the urethane resin and the polyimide resin and is integrated with the urethane resin layer 21 and the polyimide resin layer 22 by incorporating the urethane resin into the polyimide resin layer 22 can be easily and reliably formed and it is possible to obtain the resin composite laminate 10 that does not peel off as easily and less likely to have creases even when the resin composite laminate 10 is bent.

In the present embodiment, after the intermediate layer forming process, as necessary, a process of curing the polyimide resin composition contained in the polyimide resin layer 22 may be performed.

The resin composite laminate 10 of the present embodiment includes the urethane resin layer 21 containing a urethane resin which has a urethane bond and a siloxane bond, has a weight average molecular weight of 52,200 to 260,000, and is soluble in a solvent and the polyimide resin layer 22 containing a polyimide resin having an imide bond, and the peel strength between the urethane resin layer 21 and the polyimide resin layer 22 is 1.6 N or more per 10 mm in width. Thus, the resin composite laminate 10 of the present embodiment includes the intermediate layer 23 which is formed in contact with the urethane resin layer 21 and the polyimide resin layer 22 and integrated with the urethane resin layer 21 and the polyimide resin layer 22 by incorporating the urethane resin into the polyimide resin layer 22. Therefore, the resin composite laminate 10 of the present embodiment has favorable adhesion between the urethane resin layer 21 and the polyimide resin layer 22, and is unlikely to peel off and less likely to have creases even when the resin composite laminate 10 is bent.

In addition, since the resin composite laminate 10 of the present embodiment includes the urethane resin layer 21 containing a urethane resin which has a urethane bond and a siloxane bond and a weight average molecular weight of 52,200 to 260,000, it has favorable stretchability. Moreover, since the resin composite laminate 10 of the present embodiment includes the polyimide resin layer 22 containing a polyimide resin having an imide bond, it has favorable heat resistance. Specifically, it has a heat resistance of 200° C.+several tens of degrees (° C.) or higher. Therefore, the resin composite laminate 10 of the present embodiment is suitable as an element of a stretchable device.

The method of producing the resin composite laminate 10 of the present embodiment includes a solidified layer forming process in which a solidified layer composed of any one selected from the group consisting of a solidified product obtained by solidifying by drying, a semi-cured product obtained by performing semi-curing, and a partially cured product obtained by performing partial curing, of a polyimide resin composition, is formed and an intermediate layer forming process in which a urethane resin composition containing the urethane resin and the solvent is applied onto the solidified layer and solidified to form the intermediate layer 23 in contact with the urethane resin layer 21 and the polyimide resin layer 22. Therefore, according to the method of producing the resin composite laminate 10 of the present embodiment, the resin composite laminate 10 of the present embodiment including the urethane resin layer 21, the polyimide resin layer 22 and the intermediate layer 23 integrated with the urethane resin layer 21 and the polyimide resin layer 22 by incorporating the urethane resin into the polyimide resin layer 22 can be produced.

### [Stretchable Device]

FIG. 2 is a schematic view showing an example of a stretchable device according to one embodiment of the present invention.

A stretchable device 1 of the present embodiment shown in FIG. 2 has a configuration in which a first sheet 11, a second sheet 12, a third sheet 13 and a fourth sheet 14 are laminated in that order in the thickness direction. In this specification, these four layers (sheets) of sheets may be collectively referred to as “first sheet 11 to fourth sheet 14.”

The first sheet 11 to the fourth sheet 14 are all elements including the above resin composite laminate 10.

The first sheet 11 has a configuration in which an electrode 111 is provided together with a wiring on the surface of the resin composite laminate 10 on the side of the second sheet 12.

The second sheet 12 has a configuration in which a copper-plated member 121 is embedded or attached into the resin composite laminate 10. In the second sheet 12, vias or connection parts for connecting to wirings of other sheets are provided.

The third sheet 13 has a configuration in which an electronic component 131 is embedded or mounted in the resin composite laminate 10. In the third sheet 13, vias or connection parting for connecting to wirings of other sheets are provided. The fourth sheet 14 is composed of only the resin composite laminate 10.

As the wiring and the electrode 111, the copper-plated member 121 and the electronic component 131 provided in the stretchable device 1, those known in the field can be used.

When the first sheet 11 to the fourth sheet 14 are laminated, the wiring and the electrode 111 on the first sheet 11 come in contact with the copper-plated member 121 in the second sheet 12, and the copper-plated member 121 comes into contact with the electronic component 131 in the third sheet 13. The fourth sheet 14 is provided on the first sheet 11, the second sheet 12 and the third sheet 13 so that the wiring, the electrode 111, the copper-plated member 121, and the electronic component 131 are not exposed, and functions as a sealing layer.

For example, the stretchable device 1 can be produced by laminating the first sheet 11, the second sheet 12, the third sheet 13, and the fourth sheet 14 so that they are disposed in that order.

The lamination order of these sheets when the stretchable device 1 is produced is not particularly limited.

For example, the first sheet 11 can be produced by adhering a conductive composition for forming the wiring and the electrode 111 to one surface of the resin composite laminate 10 by a printing method and drying it to form a conductive layer.

For example, the second sheet 12 can be produced by disposing the copper-plated member 121 on the surface of the first sheet 11 on which the wiring and the electrode 111 are formed, and using this as a base material, forming the resin composite laminate 10 on the surface of the first sheet 11 on which the wiring and the electrode 111 are formed using the above production method. In this case, the copper-plated member 121 penetrates through the second sheet 12.

In addition, the second sheet 12 may be produced by a method of forming the resin composite laminate 10 on the surface of the first sheet 11 on which the wiring and the electrode 111 are formed and attaching the copper-plated member 121 onto the resin composite laminate 10.

For example, the third sheet 13 can be produced by disposing the electronic component 131 on the surface of the second sheet 12 on the side opposite to the first sheet 11, and using this as a base material, forming the resin composite laminate 10 on the surface of the second sheet 12 on the side opposite to the first sheet 11 (that is, the surface on which the electronic component 131 is disposed). In this case, the electronic component 131 penetrates through the third sheet 13.

The fourth sheet 14 can be produced by using the third sheet 13 as a base material, and forming the resin composite laminate 10 on the surface of the third sheet 13 on the side opposite to the second sheet 12.

According to the above process, the stretchable device 1 of the present embodiment shown in FIG. 2 is obtained.

The stretchable device of the present embodiment is not limited to the stretchable device 1 shown in FIG. 2, and a part of the configuration may be changed, deleted or added without departing from the spirit of the present invention.

For example, although the stretchable device 1 of the present embodiment has four sheets, it may have only one sheet or a plurality of sheets of a number other than four, and the number of sheets in the stretchable device can be arbitrarily set according to purposes of the stretchable device.

In addition, in the stretchable device 1 of the present embodiment, the sheet including the resin composite laminate 10 includes a wiring, an electrode, a copper-plated member or an electronic component, but it may have other configurations.

The stretchable device 1 of the present embodiment may have a base material layer. The base material layer can be arbitrarily selected according to purposes of the stretchable device 1, and may be a known layer and is not particularly limited.

As the base material layer, for example, a release sheet having an adhesive layer for attaching the stretchable device 1 to an object to be used is an exemplary example. A release sheet which is attached to one surface or both surfaces of the stretchable device 1 and thus protects the stretchable device 1 during storage, can be easily peeled off from the stretchable device 1 when the stretchable device 1 is used.

The stretchable device 1 of the present embodiment includes an element containing the resin composite laminate 10 of the present embodiment. Therefore, the stretchable device 1 of the present embodiment is less likely to have creases even when the stretchable device 1 is bent and has sufficient stretchability and heat resistance. Therefore, the stretchable device 1 of the present embodiment is used in a usage environment in which it repeatedly expands and contracts, and is suitable for applications such as bending and winding in which a curved surface is changed and stress is applied, and applications in which stretching occurs according to the body movement. In addition, the stretchable device of the present embodiment is suitable when an electronic component, a thin film sensor or the like is mounted on an element and when high power is used. Therefore, the stretchable device 1 of the present embodiment can be suitably used for a wearable device or the like.

The embodiments of the present invention have been described in detail above, and configurations and combinations thereof in the embodiments are only examples, and additions, omissions, substitutions, and other modifications of the configurations can be made without departing from the spirit and scope of the present invention.

### EXAMPLES

Hereinafter, the present invention will be described in more detail with reference to specific examples. However, the present invention is not limited to the following examples.

Raw materials used for producing the urethane resin composition are shown below.

### Resin (a)

(a)-1: urethane acrylate oligomer (product name: UN-5500, commercially available from Negami Chemical Industrial Co., Ltd.)

### ·Resin (b)

(b)-1: methacrylate-modified polydimethylsiloxane having one end modified with a methacryloyl group (product name: Silaplane (registered trademark) FM-0721, commercially available from JNC)
   Polymerization initiator (c)
(c)-1: dimethyl 2,2′-azobis(2-methylpropionate), azo polymerization initiator (product name: V601, commercially available from FUJIFILM Wako Pure Chemical Corporation)

### RAFT Agent

(1)-1: RAFT agent represented by the following Formula (1)-1 (commercially available from FUJIFILM Wako Pure Chemical Corporation)

### Solvent

MEK: methyl ethyl ketone

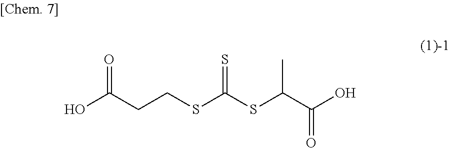

### <Production of Urethane Resin Composition>

### Synthesis Example 1

A resin (a)-1 (100 parts by mass), a resin (b)-1 (2 parts by mass), a polymerization initiator (c)-1 (1.2 parts by mass), an RAFT agent (1)-1 (2.946 parts by mass), and MEK were weighed out in a flask and mixed using a stirrer at room temperature to obtain a raw material mixture. The amount of MEK used was adjusted so that the total amount of the components other than MEK with respect to the total amount of the raw material mixture was 24.6 mass %.

Next, using liquid nitrogen, the obtained raw material mixture was cooled, and solidified, and the inside of the closed flask was vacuum-deaerated. Next, in a nitrogen atmosphere, using an oil bath, the raw material mixture was dissolved, the temperature was continuously raised with stirring, and a polymerization reaction was performed at 90° ° C. for 55 minutes.

Then, the reaction product was diluted with MEK to produce a urethane resin composition of Synthesis Example 1 containing 24.6 mass % of the urethane resin.

### Synthesis Example 2

The reaction product was diluted using N,N-dimethylacetamide (DMAc) in place of MEK to produce a urethane resin composition of Synthesis Example 2 containing 24.6 mass % of the same urethane resin as in Synthesis Example 1.

### Synthesis Example 3

A polymerization reaction was performed in the same manner as in Synthesis Example 1 except that a raw material mixture in which the amount of the polymerization initiator (c)-1 used was 0.8 parts by mass was used and the polymerization reaction time was 180 minutes.

Then, the reaction product was diluted with N,N-dimethylacetamide (DMAc) to produce a urethane resin composition of Synthesis Example 3 containing 24.6 mass % of the urethane resin.

### Synthesis Example 4

A polymerization reaction was performed in the same manner as in Synthesis Example 1 except that a raw material mixture in which the amount of the polymerization initiator (c)-1 used was 1.6 parts by mass was used, and the polymerization reaction time was 30 minutes.

Then, the reaction product was diluted with N,N-dimethylacetamide (DMAc) to produce a urethane resin composition of Synthesis Example 4 containing 24.6 mass % of the urethane resin.

Table 1 shows the solvents (diluting solvents) used for diluting the reaction products in Synthesis Example 1 to Synthesis Example 4.

TABLE 1

| | | Urethane | Urethane | | | | Polyimide |
|---|---|---|---|---|---|---|---|
| | | resin | resin | | | | resin |
| | Urethane | molecular | layer | | Other | Polyimide | layer |
| | resin | weight | thickness | Diluting | resin | resin | thickness |
| | layer | (Mw) | (μm) | solvent | layer | layer | (μm) |
| Comparative | — | — | 100 | | Urethane | Production | 10 |
| Example 1 | | | | | modified | Example 1 | |
| | | | | | epoxy | | |
| | | | | | resin | | |
| Comparative | Curing | 130000 | 100 | | — | Production | 10 |
| Example 2 | type | | | | | Example 1 | |
| Comparative | Synthesis | 144000 | 100 | MEK | — | Production | 10 |
| Example 3 | Example 1 | | | | | Example 3 | |
| Example 1 | Synthesis | 144000 | 100 | MEK | — | Production | 10 |
| | Example 1 | | | | | Example 1 | |
| Example 2 | Synthesis | 144000 | 100 | MEK | — | Production | 10 |
| | Example 1 | | | | | Example 2 | |
| Example 3 | Synthesis | 144000 | 100 | DMAc | — | Production | 17 |
| | Example 2 | | | | | Example 1 | |
| Example 4 | Synthesis | 144000 | 100 | DMAc | — | Production | 10 |
| | Example 2 | | | | | Example 1 | |
| Example 5 | Synthesis | 260000 | 100 | DMAc | — | Production | 10 |
| | Example 3 | | | | | Example 1 | |
| Example 6 | Synthesis | 52200 | 100 | DMAc | — | Production | 10 |
| | Example 4 | | | | | Example 1 | |

| | | | | | Crease: | Crease: | |
|---|---|---|---|---|---|---|---|
| | Solvent in | | | | side of | side of | |
| | polyimide | Peel | | Tensile | urethane | polyimide | |
| | resin | strength | Elongation | strength | resin | resin | Crease |
| | composition | (N) | (%) | (N) | layer | layer | evaluation |
| Comparative | DMAc | 1.4 | 43 | 7.0 | Creases | Creases | C |
| Example 1 | | | | | | | |
| Comparative | DMAc | 0.7 | 20 | 6.1 | Creases | Creases | C |
| Example 2 | | | | | | | |
| Comparative | NMP | 1.55 | 35.2 | 11.25 | Creases | Creases | C |
| Example 3 | | | | | | | |
| Example 1 | DMAc | 2.2 | 22.4 | 4.35 | Creases | No | B |
| | | | | | | creases | |
| Example 2 | NMP | 3.1 | 39.7 | 11.6 | Creases | No | B |
| | | | | | | creases | |
| Example 3 | DMAc | 4.7 | 24.4 | 4.45 | Creases | No | B |
| | | | | | | creases | |
| Example 4 | DMAc | 4.1 | 47.15 | 0.65 | No | No | A |
| | | | | | creases | creases | |
| Example 5 | DMAc | 4.5 | 43 | 0.95 | No | No | A |
| | | | | | creases | creases | |
| Example 6 | DMAc | 3.8 | 70.5 | 0.35 | No | No | A |
| | | | | | creases | creases | |

### <Production of Polyimide Resin Layer>

### Production Example 1

An aromatic polyimide resin having an aromatic polyimide as a main framework and composed of an aliphatic hydrocarbon chain or an alicyclic framework was dissolved in N,N-dimethylacetamide (DMAc) to produce a polyimide resin composition of Production Example 1 containing 0.5 to 10 mass % of the polyimide resin.

The polyimide resin composition of Production Example 1 was applied onto a release film using a spray coater and dried at 90° C. for 60 minutes and solidified without performing a curing reaction. This operation was repeated to form a solidified layer of Production Example 1 on the release film.

The completion of solidification (formation of a solidified layer) by drying the polyimide resin composition was confirmed by performing thermogravimetric analysis, which showed that the change in the mass of the polyimide resin composition being dried was 2 mass % or less.

### Production Example 2

BPDA (3,3′,4,4′-biphenyltetracarboxylic acid dianhydride) and a monomer having a silicone structure were polymerized to obtain a silicone modified polyimide resin in which the silicone structure was bonded to the polyimide chain. The obtained silicone modified polyimide resin was dissolved in N-methyl-2-pyrrolidone (NMP) to produce a polyimide resin composition of Production Example 2 containing 0.5 to 10 mass % of the polyimide resin.

The polyimide resin composition of Production Example 2 was applied onto a glass substrate using an applicator and dried at 80° ° C. for 30 minutes. Then, in a drying furnace in a nitrogen atmosphere, a curing reaction was performed at 200° ° C. for 30 minutes, cooling was performed to room temperature, peeling off from the glass substrate was performed in water, and a solidified layer of Production Example 2 composed of a semi-cured product obtained by performing semi-curing was formed.

The formation of the semi-cured product (solidified layer) by semi-curing the polyimide resin composition was confirmed by collecting three specimens from the solidified layer of Production Example 2, performing an electrical insulation test thereon, and performing comparison with the results of the electrical insulation test for the cured film of the polyimide resin composition.

### Production Example 3

A diphenyl compound and an aromatic carboxylic acid were polymerized to obtain a polyamide-imide resin which was an isocyanate compound. The obtained polyamide-imide resin was dissolved in N-methyl-2-pyrrolidone (NMP) to produce a polyimide resin composition of Production Example 3 containing 0.5 to 10 mass % of the polyimide resin.

The polyimide resin composition of Production Example 3 was applied onto a glass substrate using an applicator and dried at 80° ° C. for 30 minutes. Then, in a drying furnace in a nitrogen atmosphere, a curing reaction was performed at 200° ° C. for 30 minutes, cooling was performed to room temperature, peeling off from the glass substrate was performed in water, and a solidified layer of Production Example 3 composed of a cured product that had been cured was formed.

The formation of the cured product (solidified layer) by curing the polyimide resin composition was confirmed by collecting three specimens from the solidified layer of Production Example 3, performing a tensile test thereon, and performing comparison with the results of the tensile test for the cured film of the polyimide resin composition.

### <Production of Resin Composite Laminate>

### Example 1

The urethane resin composition of Synthesis Example 1 was applied onto the solidified layer having a thickness of 10 μm of Production Example 1 and dried at 80° C. for 10 minutes to obtain a resin composite laminate of Example 1.

### Example 2

The urethane resin composition of Synthesis Example 1 was applied onto the solidified layer having a thickness of 10 μm of Production Example 2 and dried at 80° C. for 10 minutes to obtain a resin composite laminate of Example 2.

### Example 3

The urethane resin composition of Synthesis Example 2 was applied onto the solidified layer having a thickness of 17 μm of Production Example 1 and dried at 80° C. for 10 minutes to obtain a resin composite laminate of Example 3.

### Example 4

The urethane resin composition of Synthesis Example 2 was applied onto the solidified layer having a thickness of 10 μm of Production Example 1 and dried at 80° C. for 10 minutes to obtain a resin composite laminate of Example 4.

### Example 5

The urethane resin composition of Synthesis Example 3 was applied onto the solidified layer having a thickness of 10 μm of Production Example 1 and dried at 80° C. for 10 minutes to obtain a resin composite laminate of Example 5.

### Example 6

The urethane resin composition of Synthesis Example 4 was applied onto the solidified layer having a thickness of 10 μm of Production Example 1 and dried at 80° C. for 10 minutes to obtain a resin composite laminate of Example 6.

In Example 1 to Example 6, the completion of solidification by drying the urethane resin composition was confirmed by performing thermogravimetric analysis, which showed that no change in the mass of the urethane resin composition being dried.

### Comparative Example 1

A urethane modified epoxy resin composition was applied onto a metal foil using an applicator and dried at 80° C. for 30 minutes and then heated at 130° C. for 60 minutes, and cured to prepare a urethane modified epoxy resin layer having a thickness of 100 μm.

As the urethane modified epoxy resin composition, a composition containing 20 to 50 mass % of a urethane modified epoxy resin obtained by dissolving a bisphenol A type epoxy resin containing a urethane structure in a solvent was used.

The urethane modified epoxy resin layer obtained in this manner was laminated on the solidified layer having a thickness of 10 μm of Production Example 1 to obtain a resin composite laminate of Comparative Example 1.

### Comparative Example 2

A urethane resin cured product having a thickness of 100 μm containing a urethane resin insoluble in a solvent was prepared. As the urethane resin insoluble in a solvent, a resin in which hexanediisocyanate, 4,4-diphenylmethane diisocyanate, and a polyether compound were polymerized was used.

Then, a urethane resin cured product was placed on a separately prepared solidified layer having a thickness of 10 μm of Production Example 1, and the urethane resin cured product was attached onto the solidified layer by a method of compressing under conditions of 50° ° C. and 1,000 kgf/cm² to obtain a resin composite laminate of Comparative Example 2.

### Comparative Example 3

The urethane resin composition of Synthesis Example 1 was applied onto the solidified layer (polyimide resin layer) having a thickness of 10 μm of Production Example 3 and dried at 80° ° C. for 10 minutes to obtain a resin composite laminate of Comparative Example 3.

In Comparative Example 3, the completion of solidification by drying the urethane resin composition was confirmed by performing thermogravimetric analysis, which showed that no change in the mass of the urethane resin composition being dried.

Table 1 shows the thickness of the urethane resin layer (the urethane modified epoxy resin layer for Comparative Example 1), the thickness of the polyimide resin layer, and the solvents contained in the polyimide resin composition for the resin composite laminates of Example 1 to Example 6, and Comparative Example 1 to Comparative Example 3 obtained in this manner.

In addition, for the resin composite laminates of Example 1 to Example 6, and Comparative Example 1 to Comparative Example 3, the weight average molecular weight (Mw), and the elongation and tensile strength per 10 mm in width of the urethane resins were measured by the following method. The results are shown in Table 1.

### “Measurement of Weight Average Molecular Weight (Mw) of Urethane Resin”

The resin composite laminate was added to diethylene glycol monobutyl ether (BCA) as a solvent, and heated and dissolved while mixing to prepare a 15 mass % resin solution. The obtained resin solution was diluted 50-fold with tetrahydrofuran (THF), vibrated by a vibrator, mixed for 10 hours, and then filtered using a polytetrafluoroethylene (PTFA) filter. The solution that has passed through the PTFA filter was used as a measurement sample for measuring the weight average molecular weight of the urethane resin by a gel permeation chromatography (GPC) method.

The weight average molecular weight was measured by connecting three columns for GPC (product name: Shodex (registered trademark) LF-404, commercially available from Showa Denko K.K.) in series, and by using a molecular weight measuring device (product name: Shodex (registered trademark) GPC-104, commercially available from Showa Denko K.K.). The temperature of the columns for GPC was set to 40° C., and the weight average molecular weight (Mw) of the measurement sample obtained above was measured using tetrahydrofuran (THF) as a mobile phase. The weight average molecular weight was calculated using a calibration curve created in advance.

Here, in the resin composite laminate of Comparative Example 2, since the filtration pressure when the resin solution was filtered using a PTFA filter was high, there was a likelihood of the error in the measurement result of the weight average molecular weight (Mw) measured by the above method increasing.

### “Elongation Per 10 mm in Width”

Five strip-like measurement samples having a width of 10 mm and a length of 35 mm were cut out from each resin composite laminate. For the measurement samples, the elongations were calculated by the following method, and the average value thereof was used as an elongation.

A metal substrate was interposed between grip parts on the top and bottom of the measuring device, and a measurement sample was fixed to the metal substrate with a double-sided tape so that the measurement part had a width of 10 mm and a length of 10 mm. Then, the measurement sample was pulled using a tensile tester (product name: Autograph AGS-5kNX, commercially available from Shimadzu Corporation) at a tensile speed of 10 mm/min. Then, the length of the measurement sample when broken was measured, and the length of 10 mm before pulling was subtracted from the length to calculate an elongation.

### “Tensile Strength Per 10 mm in Width”

Five strip-like measurement samples having a width of 10 mm and a length of 35 mm were cut out from each resin composite laminate. For the measurement samples, the maximum values of the tensile strengths were calculated by the following method, and the average value thereof was used as a tensile strength.

A metal substrate was interposed between grip parts on the top and bottom of the measuring device, and a measurement sample was fixed to the metal substrate with a double-sided tape so that the measurement part had a width of 10 mm and a length of 10 mm. Then, the measurement sample was pulled using a tensile tester (product name: Autograph AGS-5kNX, commercially available from Shimadzu Corporation) at a tensile speed of 10 mm/min. Then, the maximum value of the tensile strength of the measurement sample was measured.

In addition, samples corresponding to the resin composite laminates of Example 1 to Example 6, and Comparative Example 1 to Comparative Example 3 were prepared, and the peel strength per 10 mm in width was measured by the following method. The results are shown in Table 1.

### “Peel Strength Per 10 mm in Width”

Samples of Example 1 to Example 6, and Comparative Example 3 in which a non-adhesive tape was disposed in a part between the urethane resin layer and the polyimide resin layer were prepared in the same manner as in the resin composite laminates of Example 1 to Example 6 and Comparative Example 3 except that, before the urethane resin composition was applied onto the solidified layer, a peelable non-adhesive tape was installed at the end of the coating target surface on the solidified layer.

In addition, a sample of Comparative Example 1 in which a non-adhesive tape was disposed in a part between the urethane modified epoxy resin layer and the polyimide resin layer was prepared in the same manner as in the resin composite laminate of Comparative Example 1 except that, before the urethane modified epoxy resin layer was laminated on the solidified layer, a peelable non-adhesive tape was installed at the end of the lamination target surface on the solidified layer.

In addition, a sample of Comparative Example 2 in which a non-adhesive tape was disposed in a part between the urethane resin layer and the polyimide resin layer was prepared in the same manner as in the resin composite laminate of Comparative Example 2 except that, before the urethane resin cured product was installed on the solidified layer, a peelable non-adhesive tape was installed at the end of the installation target surface on the solidified layer.

Each sample was cut into strips to obtain test pieces having a width of 10 mm and a length of 100 mm in which the non-adhesive tape was disposed only in the region from the substantially central part in the length direction to one end.

The surface of each test piece on the side of the urethane resin layer was fixed onto the resin substrate using a double-sided tape so that air did not enter. Then, the non-adhesive tape was peeled off from the test piece, the end surface on the side of the polyimide resin layer was pulled in a direction opposite to the end surface on the side of the urethane resin layer using a tensile tester (product name: FTN-13A, commercially available from Aikoh Engineering Co., Ltd.) at a tensile speed of 5.0 mm/min, the tensile strength of the stable part excluding the start point and the end point were measured at 5 points, and the average value thereof was used as the peel strength.

In addition, for the resin composite laminates of Example 1 to Example 6, and Comparative Example 1 to Comparative Example 3, it was observed by the following method whether there were creases, and evaluation was performed according to the following criteria. The results are shown in Table 1.

### “Crease: Side of Urethane Resin Layer”

Each resin composite laminate was valley-folded so that the surface on the side of the urethane resin layer was on the inner side, and under conditions in which an angle (bending angle) formed by two adjacent surfaces with the bending line therebetween was 0° and the bending radius R of the bending line was 0.01 mm or less, two adjacent surfaces with the bending line therebetween were pressed against each other and brought into contact with each other for 1 second or longer. Then, the force pressing against two adjacent surfaces with the bending line therebetween was released, the state was left until the angle formed by the two adjacent surfaces with the bending line therebetween was 180°, and it was visually observed whether there were creases (bending marks) on the surface on the side of the urethane resin layer.

### “Crease: Side of Polyimide Resin Layer”

Each resin composite laminate was valley-folded so that the surface on the side of the polyimide resin layer was on the inner side, and under conditions in which an angle (bending angle) formed by two adjacent surfaces with the bending line therebetween was 0° and the bending radius R of the bending line was 0.01 mm or less, two adjacent surfaces with the bending line therebetween were pressed against each other and brought into contact with each other for 1 second or longer. Then, the force pressing against two adjacent surfaces with the bending line therebetween was released, the state was left until the angle formed by the two adjacent surfaces with the bending line therebetween was 180°, and it was visually observed whether there were creases (bending marks) on the surface on the side of the polyimide resin layer.

### “Crease Evaluation”

A: there were no creases on the side of the urethane resin layer or on the side of the polyimide resin layer.
B: there were creases on the side of the urethane resin layer, and there were no creases on the side of the polyimide resin layer,
C: there were creases on both the side of the urethane resin layer and the side of the polyimide resin layer.

As shown in Table 1, the resin composite laminates of Example 1 to Example 6 had a peel strength of 1.6 N or more, and the urethane resin layer and the polyimide resin layer were unlikely to peel off.

In addition, the resin composite laminates of Example 1 to Example 6 had a crease evaluation of A or B.

On the other hand, in all of Comparative Example 1 having a urethane modified epoxy resin layer in place of a urethane resin layer, Comparative Example 2 in which a urethane resin layer containing a urethane resin insoluble in a solvent was attached to a polyimide resin layer, and Comparative Example 3 in which no intermediate layer was provided because a polyimide resin layer composed of a cured product that had been cured was used, the peel strength was insufficient, and the crease evaluation was C.

### INDUSTRIAL APPLICABILITY

The present invention can be used for stretchable devices and their production.

### REFERENCE SIGNS LIST

1 Stretchable device
10 Resin composite laminate
11 First sheet
12 Second sheet
13 Third sheet
14 Fourth sheet
111 Electrode
121 Copper-plated member
131 Electronic component

The invention claimed is:

1. A resin composite laminate, comprising:
a urethane resin layer containing a urethane resin which has a urethane bond and a siloxane bond, has a weight average molecular weight of 52,200 to 260,000, and is soluble in a solvent, and
a polyimide resin layer containing a polyimide resin having an imide bond,
wherein a peel strength between the urethane resin layer and the polyimide resin layer is 1.6 N or more per 10 mm in width.

2. The resin composite laminate according to claim 1,
wherein the urethane resin has a group represented by the following General Formula (11), (21) or (31), a urethane bond, and a siloxane bond: 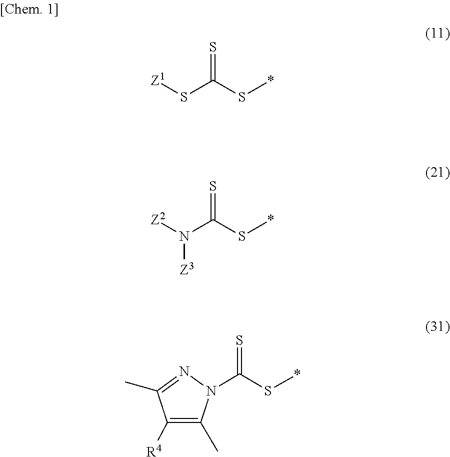
(in the formulae, Z¹ is an alkyl group, and one or more hydrogen atoms in the alkyl group may be substituted with a cyano group, a carboxy group or a methoxycarbonyl group, and two or more of the substituents may be the same as or different from each other; Z² is an alkyl group; Z³ is an aryl group; R⁴ is a hydrogen atom or a halogen atom; and the bond with the symbol * is formed with the bonding destination of the group represented by General Formula (11), (21) or (31)).

3. The resin composite laminate according to claim 1,
wherein the polyimide resin is soluble in the solvent.

4. The resin composite laminate according to claim 1,
wherein the polyimide resin is any one selected from a group consisting of a silicone modified polyimide resin, a polyamide-imide resin, an aromatic polyimide resin, an epoxy modified polyimide, and a urethane modified polyimide.

5. The resin composite laminate according to claim 1,
wherein a thickness of the polyimide resin layer is 10 μm or less.

6. The resin composite laminate according to claim 1,
wherein a tensile strength per 10 mm in width is 4.35 N or less.

7. A method of producing the resin composite laminate according to claim 1, comprising:
a solidified layer forming process in which a solidified layer composed of any one selected from a group consisting of a solidified product obtained by solidifying by drying, a semi-cured product obtained by performing semi-curing, and a partially cured product obtained by performing partial curing, of a polyimide resin composition containing a polyimide resin is formed; and
an intermediate layer forming process in which a urethane resin composition containing the urethane resin and the solvent is applied onto the solidified layer, dried and solidified to form the urethane resin layer and the polyimide resin layer, and an intermediate layer is formed in contact with the urethane resin layer and the polyimide resin layer.

8. The method of producing a resin composite laminate according to claim 7,
wherein the polyimide resin is soluble in the solvent, and
wherein, in the intermediate layer forming process, the urethane resin composition is applied, and thus the polyimide resin contained in the solidified layer is dissolved in the solvent.

9. A stretchable device comprising an element containing the resin composite laminate according to claim 1.
